(19) United States
(12) Patent Application Publication
(10) Pub. No.: US 2006/0186616 A1
(43) Pub. Date: Aug. 24, 2006

(54) SUSPENSION SYSTEM FOR A VEHICLE

(76) Inventor: Emil Rudiger, Fort St. John (CA)

Correspondence Address: LAW OFFICE OF MARC D. MACHTINGER, LTD., 750 W. LAKE COOK ROAD, SUITE 350, BUFFALO GROVE, IL, 60089, US

(21) Appl. No.: 10/907,604

(22) Filed: Apr. 7, 2005

(30) Foreign Application Priority Data
Feb. 22, 2005 (CA) 2,498,403

(51) Int. Cl. B60G 17/00

(52) U.S. Cl. 280/6.15

(57) ABSTRACT

A suspension system for a vehicle such as a trailer permitting the vehicle to be raised or lowered and providing a cushioned ride when the vehicle is in motion. The suspension system comprises a vehicle having a frame, a pivoting arm having a shoulder, a wheel end, and an elbow forming a bend between the shoulder and the wheel end, the pivoting arm pivotally attached to a suspension means at the shoulder, to the frame at the elbow, and to a wheel at the wheel end, the suspension means also pivotally attached to the frame in such fashion as to be in-line with the wheel and movable between an extended position and a retracted position such that when the suspension means is in an extended position, the frame is raised, and when the suspension means is in a retracted position, the frame is lowered. The suspension means may be an air suspension means, such as a double-acting pneumatic cylinder or an air bag.

### BACKGROUND OF THE INVENTION

Trailers exist that demonstrate some capability to be raised or lowered, such that in a raised position, the trailer can be moved forwards and backwards, but when the trailer is lowered, it is rendered immovable.

Other trailers exist that benefit from an air suspension system that provides the trailer with a cushioned ride. At least some of these trailers have wheels capable of movement independently of each other.

However, the inventor of the present invention is not aware of a trailer or other vehicle that combines these two features using a structure as disclosed in the following specification.

### SUMMARY OF THE INVENTION

The present invention relates to suspension systems for vehicles, including trailers. More specifically, the present invention relates to a suspension system for a vehicle that permits the vehicle to be raised or lowered, such that when the vehicle is lowered, it is rendered immovable. At the same time, when the vehicle is raised, the present invention provides for a cushioned ride and independent suspension for each of the wheels.

In one aspect of the invention, there is provided wheel mounted apparatus comprising a frame and a pair of wheel suspension assemblies mounted on the frame. Each wheel suspension assembly comprises a wheel mounted for rotation on a pivot arm, the pivot arm being attached to the frame at a fulcrum; and a suspension arm mounted on the frame, and being movable between an extended position and a retracted position, the suspension arm being pivotally attached to an extension of the pivot arm, such that extension of the suspension arm raises the frame, and retraction of the suspension arm lowers the frame.

In another aspect of the invention, there is provided a wheel-mounted apparatus comprising a frame; a pivoting arm having a shoulder, a wheel end supporting a wheel, and an elbow forming a bend between the shoulder and the wheel end, the pivoting arm pivotally attached at the elbow to the frame. A suspension means is attached to the frame and is movable between an extended position and a retracted position. The suspension means is pivotally attached to the pivoting arm at the shoulder and to the frame. The suspension means is preferably in-line with the wheel. The frame is raised when the suspension means is in an extended position and lowered when the suspension means is in a retracted position.

The suspension means or arm may be an air suspension means capable of providing a cushioned ride. For example, the air suspension means is a double acting pneumatic cylinder having a piston rod, the piston rod being attached to the shoulder of the pivoting arm. In a further aspect of the invention, the air suspension means may be an air bag.

In a further aspect of the invention, the wheel mounted apparatus is a trailer.

These and other aspects of the invention are set out in the claims, which are incorporated here by reference.

### BRIEF DESCRIPTION OF THE FIGURES

Preferred embodiments of the invention will now be described with reference to the figures, in which like reference characters denote like elements, by way of example, and in which:

FIG. 1 is a perspective view of one embodiment of the suspension system showing the wheel in a lowered position;

FIG. 2 is a perspective view of the suspension system showing the wheel retracted;

FIG. 3 is a side view of the suspension system showing the wheel in a lowered position;

FIG. 4 is a side view of the suspension system showing the wheel in a retracted position; and

FIG. 5 is a top view of a trailer according to the present invention.

### DETAILED DESCRIPTION OF PREFERRED EMBODIMENTS

In the claims, the word “comprising” is used in its inclusive sense and does not exclude other elements being present. The indefinite article “a” before a claim feature does not exclude more than one of the feature being present.

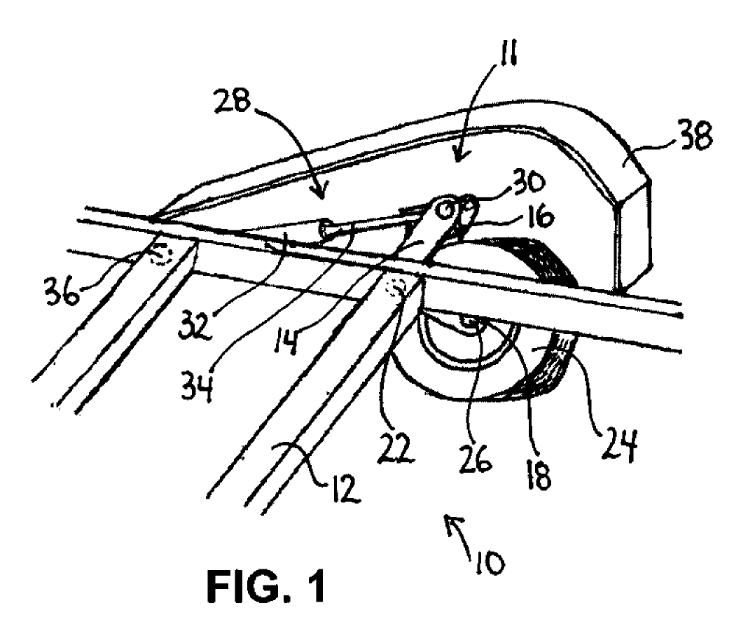

Referring to FIGS. 1 to 4, a suspension system for a vehicle 10 has a frame 12 and at least one suspension assembly 11. The suspension assembly 11 has a pivoting arm 14 having a shoulder 16, a wheel end 18, and an elbow 20 forming a bend 21 between the shoulder 16 and the wheel end 18. The pivoting arm 14 is attached to the frame 12 by a first pivoting means 22 such as a spindle with a shaft welded to the frame 12 and the spindle bolted to the pivoting arm 14. A wheel 24 is attached to the pivoting arm 14 at the wheel end 18 by an axle 26 attached to the wheel end. The axle 26 may be a spindle with a shaft welded to the wheel end 18 with the spindle attached to the wheel 24. In one embodiment, the pivoting arm 14 is made of T1 steel, but any material strong enough to be suitable for the purpose may be used. It should be understood that the elbow 20 may form a bend 21 ranging from 0° to 180°, but in a preferred embodiment, the elbow 20 forms a bend 21 between 60° and 120°. The pivoting arm 14 may be considered to comprise two portions, a pivot arm to which the wheel is attached, and an extension of the pivot arm to which a suspension arm 28 is attached. The extension portion is preferably at an angle to the portion of the pivot arm to which the wheel is attached. The pivot arm 14 thus forms a lever having a fulcrum between the force application points. The force application points are where the suspension arm and the wheel attach to the pivot arm 14.

The suspension assembly 11 has a suspension arm or suspension means 28 attached to the pivoting arm 14 at the shoulder 16 by a pivoting means 30. In one embodiment of the invention, the suspension means 28 is a double-acting pneumatic cylinder 32 having a piston rod 34, but the suspension means 28 may be an air bag or other devices known in the art capable of providing a cushioned ride. Hence, the term suspension as used in this patent document means a device that provides shock absorbance. In this case, the piston rod 34 is attached to the shoulder 16 by the pivoting means 30. It will be observed that the suspension means 28 is positioned in-line with the wheel 24. In-line with the wheel means that a central axis of the suspension means 28 lies in a plane that is perpendicular to the wheel axis and that intersects the wheel itself. Preferably, an extension of the central axis of the suspension means would pass through a plane that is perpendicular to an axis of the wheel and that bisects the wheel. In a preferred embodiment, the suspension means 28 is attached to the frame by a pivoting means 36 at the same level as the pivoting means 22, but any position on the frame 12 which permits sufficient travel of the suspension means 28 from an extended position to a retracted position would be suitable. In one embodiment, given as an example only, since the various may have varied dimensions depending on the application, the suspension means 28 is a 6″ air ram 12″ long, with approximately 10″ of travel. The air ram is connected in conventional fashion to a double regulator (not shown) and an air compressor (not shown), such as a 12 V air compressor with a day tank.

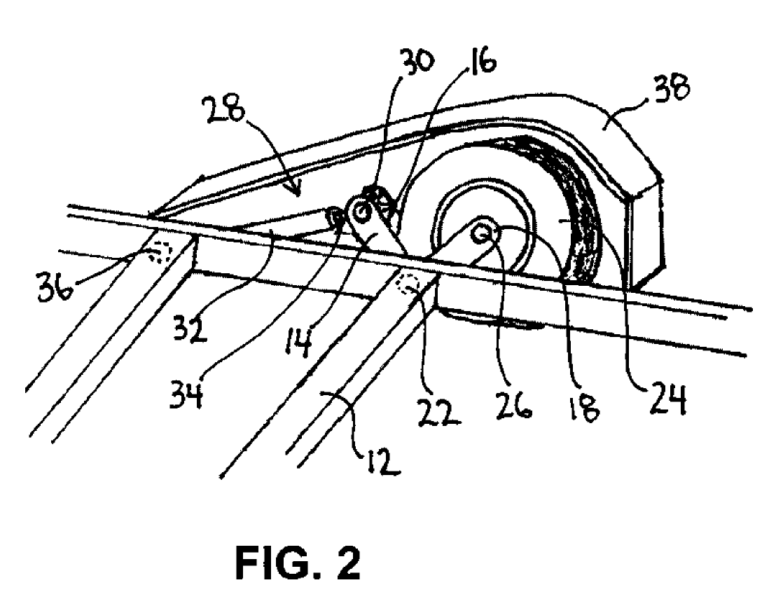

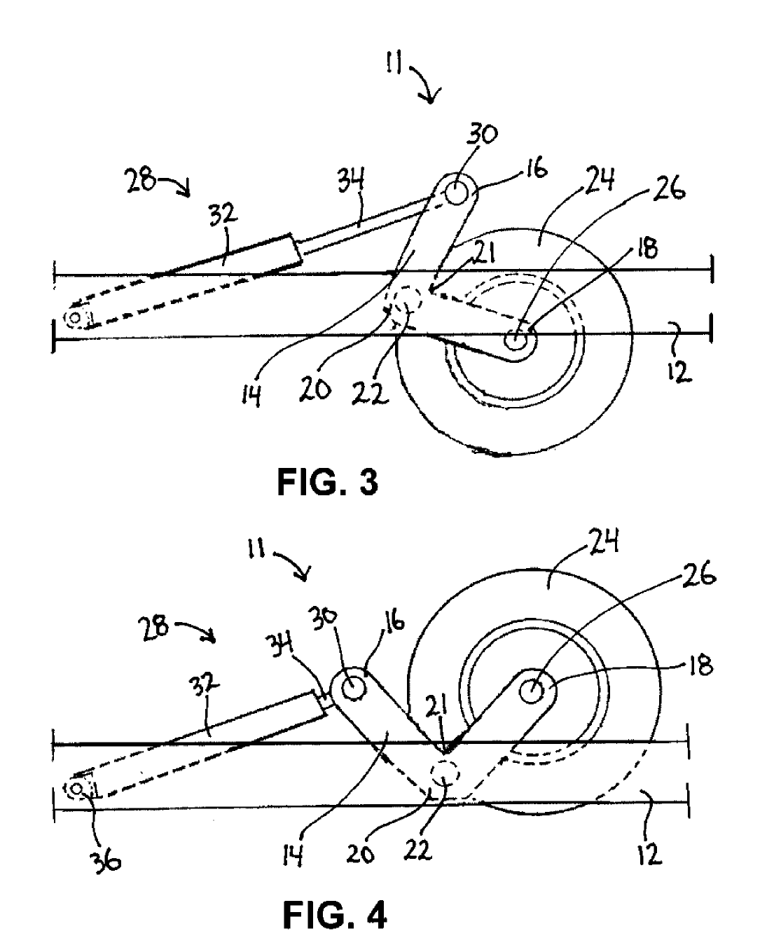

In operation, the suspension assembly 11 moves between a lowered or extended position, as shown in FIGS. 1 and 3 and a raised or retracted position, as shown in FIGS. 2 and 4. In a preferred embodiment of the invention, the double-acting pneumatic cylinder 32 has, for example, 100 psi of pressure on one side of a plunger and 10 psi of pressure in the other side of the plunger, the greater pressure on the one side of the plunger forcing the piston rod 34 to be extended outwardly from the pneumatic cylinder 32, which results in the pivoting arm 14 being moved into a lowered position with the wheel 24 touching the ground. More accurately, extending the piston rod 34 causes the frame 12 of the vehicle 10 to be raised off the ground.

By reducing the pressure on one side of the plunger within the pneumatic cylinder 32, the piston rod 34 is then retracted within the pneumatic cylinder 32, which results in the pivoting arm 14 being moved into a raised or retracted position, pulling the wheel 24 upwards, and where a wheel well 38 is provided, into the wheel well 38. More accurately, retracting the piston rod 32 causes the frame 12 of the vehicle 10 to be lowered to the ground.

Depending on the amount of elevation desired and the type of terrain over which the vehicle 10 is travelling, the pressure on both sides of the plunger within the pneumatic cylinder 32 may be adjusted by setting the regulators (not shown) to appropriate levels to provide a cushioned ride. Likewise, the frame 12 of the vehicle 10 may be lowered, and the wheel 24 retracted upwards by adjusting the pressure within the pneumatic cylinder 32 to pull the pivoting arm 14 back.

It should be understood that the suspension assembly 11 as described is independently adjustable, such that when the vehicle 10 has more than one suspension assembly 11, each suspension assembly 11 may independently cause part of the frame 12 to be raised or lowered, for example to compensate for uneven loads on the vehicle 10 or for some other reason. When the suspension means 28 of each suspension assembly 11 is in a completely retracted position, the frame 12 will be completely lowered to the ground, and the vehicle 10 will be rendered immovable.

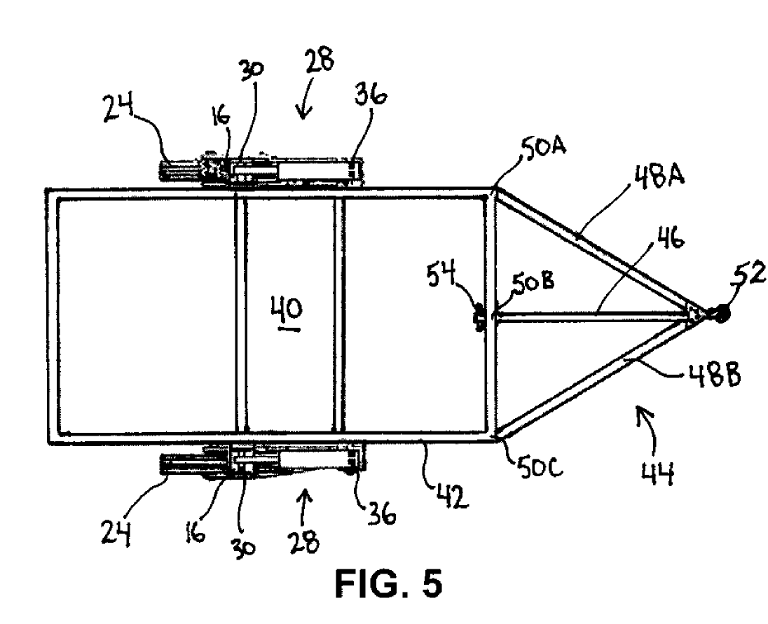

As shown in FIG. 5, in one embodiment of the invention, the vehicle for the suspension system is a trailer 40. The trailer 40 has towing assembly 44, which has a tow arm 46 and stabilizer arms 48A and 48B, with the ends of the tow arm 46 and the stabilizer arms 48A and 48B being inserted into pockets 50A, 50B, and 50C in the frame 42. It should be understood that instead of pockets 50A, 50B, 50C, any other suitable means of attaching the tow arm 46 and the stabilizer arms 48A and 48B may be used. The towing assembly 44 can be easily attached to and removed from the trailer 40 through the use of a pin 54 or other suitable attachment means to provide added security when the wheels 24 of the trailer 40 are in a retracted position. The towing assembly 44 is also equipped with a conventional hitch 52 to be connected to another towing vehicle, such as a truck or a quad.

As can be seen from FIG. 5, the suspension means 28 is in-line with the wheel 24. It should be understood that the trailer 40 could be lengthened, and additional suspension assemblies added to the trailer 40 without departing from the invention. In FIG. 5, only the frame 42 of the trailer 40 is shown, it being understood that built upon the frame 42 could be any type of trailer, such as a flat deck trailer, a storage trailer, a portable ice fishing shed, a trailer for transporting recreational vehicles, or any other type of trailer.

The suspension system of the present invention has the advantage of being compact and is capable of being used for the conversion of an existing suspension system on a trailer or other vehicle. It also provides for improved accessibility to the suspension system because the suspension assembly is mounted to the outside of the frame of the vehicle or trailer. As contemplated in a preferred embodiment, the suspension system is also inexpensive, and can be constructed out of materials that are readily available. It also does not increase the width of the trailer or vehicle, which can be an important consideration in complying with government regulations, or when travelling along narrow roadways, particularly in “off-road” conditions. Because the suspension system may have independently adjustable suspension assemblies, it permits adjustment of the vehicle to compensate for uneven loads on the vehicle.

Immaterial modifications may be made to the embodiments of the invention described here without departing from the invention.

What is claimed is:

1. Wheel mounted apparatus, comprising:
a frame;
a pivoting arm having a shoulder, a wheel end, and an elbow forming a bend between the shoulder and the wheel end, the pivoting arm attached by a first pivoting means at the elbow to the frame;
a wheel, the wheel attached to the wheel end by an axle attached to the wheel end;
a suspension means movable between an extended position and a retracted position, the suspension means attached to the pivoting arm at the shoulder by a second pivoting means and attached to the frame by a third pivoting means;
the suspension means being in-line with the wheel; and
the frame being raised when the suspension means is in an extended position and lowered when the suspension means is in a retracted position.

2. The wheel mounted apparatus of claim 1, in which the wheel mounted apparatus is a trailer.

3. The wheel mounted apparatus of claim 1, in which the suspension means is an air suspension means capable of providing a cushioned ride.

4. The wheel mounted apparatus of claim 3, in which the air suspension means is a double-acting pneumatic cylinder.

5. The wheel mounted apparatus of claim 3, in which the air suspension means is an air bag.

6. The wheel mounted apparatus of claim 1, in which the bend in the elbow forms an angle between 0° and 180°.

7. The wheel mounted apparatus of claim 6, in which the bend in the elbow forms an angle between 60° and 120°.

8. The wheel mounted apparatus of claim 1, in which the wheel mounted apparatus has a wheel well.

9. Wheel mounted apparatus, comprising:
a frame; and
a pair of wheel suspension assemblies mounted on the frame, each wheel suspension assembly comprising:
a wheel mounted for rotation on a pivot arm, the pivot arm being attached to the frame at a fulcrum; and
a suspension arm mounted on the frame, and being movable between an extended position and a retracted position, the suspension arm being pivotally attached to an extension of the pivot arm, such that extension of the suspension arm raises the frame, and retraction of the suspension arm lowers the frame.

10. The wheel mounted apparatus of claim 9, in which the suspension arm is pneumatically operated.

11. The wheel mounted apparatus of claim 10 in which the suspension arm comprises a double-acting pneumatic cylinder having a piston rod, the piston rod being attached to the extension of the pivot arm.

12. The wheel mounted apparatus of claim 10 in which the suspension arm comprises an air bag.

13. The wheel mounted apparatus of claim 9, in which the extension of the pivot arm is at angle between 0° and 180° to the pivot arm.

14. The wheel mounted apparatus of claim 9, in which the extension of the pivot arm forms an angle, in relation to the pivot arm, of between 60° and 120°.

15. The wheel mounted apparatus of claim 9, in which the wheel mounted apparatus is a flat deck trailer.

16. The wheel mounted apparatus of claim 9, in which the wheel mounted apparatus is a storage trailer.

17. The wheel mounted apparatus of claim 9, in which the wheel mounted apparatus is a portable ice fishing shed.

18. The wheel mounted apparatus of claim 9, in which the wheel mounted apparatus is a trailer for transporting recreational vehicles.

19. The wheel mounted apparatus of claim 9, in which the wheel mounted apparatus has a towing assembly removably attached to the frame, such that when the wheel mounted apparatus is in a lowered position, the towing assembly may be removed and stored to further secure the wheel mounted apparatus.

20. A vehicle, comprising:
a frame;
one or more wheel suspension assemblies mounted on the frame, each wheel suspension assembly comprising a wheel mounted for rotation on a pivot arm attached to the frame at a fulcrum and a suspension arm mounted on the frame, the suspension arm being movable between an extended position and a retracted position, the suspension arm being pivotally attached to the pivot arm at a shoulder with the fulcrum being between the shoulder and the wheel; and
each wheel suspension assembly being independently adjustable, such that when the suspension arm of any wheel suspension assembly is in an extended position, the frame is raised in relation to the wheel suspension assembly, when the suspension arm of any wheel suspension assembly is in a retracted position, the frame is lowered in relation to the wheel suspension assembly, and when the suspension arm of each wheel suspension assembly is in a retracted position, the frame is completely lowered so as to be supported by a ground surface, rendering the vehicle immovable.
